(19) United States
(12) Patent Application Publication
(10) Pub. No.: US 2016/0142919 A1
(43) Pub. Date: May 19, 2016

(54) Method and Network Node for Providing Radio Resources for Radio Communication in a Cellular Network

(71) Applicant: TELEFONAKTIEBOLAGET L M ERICSSON (PUBL), Stockholm (SE)

(72) Inventors: Robert Baldemair, Solna (SE); Jung-Fu Cheng, Fremont, CA (US); Sorour Falahati, Stockholm (SE); Mattias Frenne, Uppsala (SE); Havish Koorapaty, Saratoga, CA (US); Daniel Larsson, Stockholm (SE)

(21) Appl. No.: 14/901,156

(22) PCT Filed: Jun. 28, 2013
(86) PCT No.: PCT/SE2013/050826

§ 371 Date: Dec. 28, 2015

(51) Int. Cl. H04W 16/10

(52) U.S. Cl. CPC H04W 16/10

(57) ABSTRACT

A method and network node (600) of a cellular network, for providing radio resources in groups of resource blocks in frequency domain in a first system bandwidth (BW1) and in a second system bandwidth (BW2) that overlaps the first system bandwidth, wherein the first and second system bandwidths have a common frequency centre (CF), the radio resources being useful for radio communication with mobile terminals. A first resource block group size S1 is applied for the first system bandwidth and a second resource block group size S2=N×S1 is applied for the second system bandwidth where N is an integer. Further, radio resources are applied in the first system bandwidth according to the first resource block group size S1 and in the second system bandwidth according to the second resource block group size S2. The network node (600) then signals the applied radio resources to mobile terminals (604, 606).

### TECHNICAL FIELD

The present disclosure relates generally to a method and a network node of a cellular network for wireless communication, for providing radio resources in frequency domain in a first system bandwidth and in a second system bandwidth different than the first system bandwidth and overlapping the first system bandwidth. The radio resources can be used for radio communication with mobile terminals in the cellular network.

### BACKGROUND

In recent years, different types of cellular networks for wireless communication have been developed to provide radio access for various mobile terminals in different areas. The cellular networks are constantly improved to provide better coverage and capacity to meet the demands from subscribers using services and increasingly advanced terminals, e.g. smartphones and tablets, which may require considerable amounts of bandwidth and resources for data transport over a radio interface in the networks. Therefore, an operator of such a network constantly strives to improve capacity in the network by efficient usage of radio resources within a certain limited bandwidth which the operator has attained permission to use for radio communications in the network.

In this disclosure, the terms “mobile terminal” and “radio node” will be used, the latter representing a node of a cellular network that can communicate uplink and downlink radio signals with a mobile terminal. Another commonly used term in this field is User Equipment, UE, which is equivalent to mobile terminal in the context of this disclosure. The radio node in this disclosure may also be referred to as a base station, NodeB, e-NodeB, eNB, base transceiver station, relay, etc., depending on the terminology used. The term “network node” is also used which may be any node in the cellular network, such as a radio node, a network managing node, a radio resource managing node, a radio node controller, and so forth. Further, a mobile terminal is typically held and operated by a person, but it may also be a Machine Type Communication, MTC, device such as a stationary device that operates automatically, e.g. for executing instructions or sending measurements or other observations to the network, as automatically performed by itself.

As indicated above, during periods of high traffic load, capacity can be increased in a cellular network by allocating radio resources to different mobile terminals in an efficient manner such that as little radio resources as possible are wasted by not being useable, given the limited total amount of available radio resources within a frequency spectrum allocated to the cellular network. The radio resources are typically defined in both the frequency domain and the time domain and the following definitions are used in the standard of Long Term Evolution, LTE, developed by the Third Generation Partnership Project, 3GPP. In the time domain, the radio resources are divided into subframes of 1 ms, each comprising two slots of 0.5 ms. In the frequency domain, the radio resources are divided into subcarriers each having a frequency range of 15 kHz.

Furthermore, allocation of radio resources for transmissions in either downlink or uplink is commonly made in terms of resource blocks where a resource block extends over one slot in the time domain and over 12 contiguous subcarriers in the frequency domain, thus covering a frequency range of 12×15=180 kHz. This disclosure is concerned with the utilization of bandwidth in the frequency domain and allocation of radio resources will be discussed in terms of resource blocks. The total bandwidth used for transmissions in a cellular network is thus divided into contiguous resource blocks which are numbered across the bandwidth range used. The total number of resource blocks that can be allocated for various transmissions in a cell or coverage area is dependent on the extent of the total bandwidth used in a cellular network which is called the “system bandwidth”.

Downlink transmissions of data in a cell or coverage area are dynamically scheduled for different receiving mobile terminals and a radio node serving the cell or coverage area transmits control information indicating which terminals the data will be transmitted to and in which resource blocks, the latter being addressed in the control information by using the above resource block numbering. It is also possible to address groups of resource blocks, e.g. with 1, 2, 3 or 4 resource blocks in each resource block group, which enables use of fewer bits in the addressing of allocated radio resources when there are two or more resource blocks in a resource block group. Thereby, the signalling overhead can be limited to just a few bits since the size of a resource block group increases with increased system bandwidth.

In LTE, a set of 6 different system bandwidths has been defined, namely 1.4, 3, 5, 10, 15 and 20 MHz, to specify requirements for both mobile terminals and radio nodes for radio communication on resource blocks according to any of these system bandwidths. It was assumed that these 6 predefined system bandwidths would match spectrum allocations for most network operators known at the time. It should be noted that the LTE physical layer specification is designed for any bandwidth between 6 and 110 resource blocks, while these 6 predefined system bandwidths are those for which it currently exists test procedures, among other things. Each of these 6 system bandwidths can encompass a certain number of contiguous resource blocks, which are shown in the table 1 below. Thus, any mobile terminal configured for LTE is capable of using any of these ranges of resource blocks depending on the network's allocated system bandwidth.

TABLE 1

| System Bandwidth | Number of Resource Blocks |
|---|---|
| 1.4 | 6 |
| 3 | 15 |
| 5 | 25 |
| 10 | 50 |
| 15 | 75 |
| 20 | 100 |

LTE further defines a resource block group size that increases with increased system bandwidth such that each resource block group size is defined for a specific interval of numbers of resource blocks in the system bandwidth used, as shown in table 2 below.

TABLE 2

| Number of Resource | |
|---|---|
| Blocks | Resource block group size |
| ≦10 | 1 |
| 11-26 | 2 |
| 27-63 | 3 |
| 64-110 | 4 |

If a network operator wants to configure and apply radio resources in radio communication to make efficient use of a newly granted frequency spectrum allowing for a system bandwidth different than the above 6 predefined ones, the number of resource blocks that can be used will also differ from the numbers shown in table 1, column on the right. For example, an operator may have used the predefined system bandwidth of 5 MHz with 25 resource blocks and is at some point granted frequency spectrum allowing for a greater system bandwidth of 7 MHz which can obviously provide increased capacity for terminals that support the greater bandwidth, e.g. by enabling a greater number of contiguous resource blocks across the 7 MHz bandwidth. However, the new system bandwidth of 7 MHz is not predefined in table 1 which means that mobile terminals configured to communicate only according to the predefined system bandwidths in table 1 will not be able to communicate according to the new system bandwidth of 7 MHz. This may be the case for “old” mobile terminals, commonly referred to as “legacy terminals”, and certain low-cost terminals designed for limited price and low power consumption. However, a more advanced mobile terminal may be configured to use the 7 MHz bandwidth and can therefore be served on that system bandwidth.

In order to take advantage of the better capacity of an expanded system bandwidth, e.g. as of the above example of expanding the system bandwidth from 5 MHz to 7 MHz, it is proposed that two different configurations of system bandwidth can be used for radio communication simultaneously in a cell or coverage area for serving different mobile terminals depending on their capabilities. This is schematically illustrated in FIG. 1 where a radio node 100 covering a cell 100a is serving a set of legacy and low-cost terminals 102 using a first bandwidth configuration BW1, and at the same time is also serving another set of more advanced terminals 104 using a second bandwidth configuration BW2 greater than BW1.

With reference to the above example, the 5 MHz system bandwidth may be deployed to serve legacy and low-cost mobile terminals and the 7 MHz system bandwidth may be deployed to serve the more advanced mobile terminals in the network. The 5 MHz system bandwidth is configured with 25 resource blocks in accordance with table 1 while the 7 MHz system bandwidth can be configured with a greater number of resource blocks, e.g. not defined for legacy LTE, to provide greater capacity. The 7 MHz system bandwidth corresponds roughly to 35 resource blocks and will also address a larger resource block group with a size of 3 resource blocks as compared to the 5 MHz system bandwidth addressing a smaller resource block group with a size of 2 resource blocks, according to table 2 above.

However, when deploying two different system bandwidth configurations with different numbers of resource blocks and different sizes of resource block groups, the allocation of resource blocks for transmissions in the two system bandwidths must be made so as to avoid transmission collisions when scheduling mobile terminals across the respective system bandwidths. It is a problem that during periods of high traffic load, some parts of the total system bandwidth must be left unused to avoid collisions and the potential capacity can therefore not be fully utilized, which will be explained in more detail below.

### SUMMARY

It is an object of embodiments described herein to address at least some of the problems and issues outlined above. It is possible to achieve this object and others by using a method and a network node as defined in the attached independent claims.

According to one aspect, a method is performed by a network node of a cellular network for wireless communication, for providing radio resources in groups of resource blocks in frequency domain in a first system bandwidth and in a second system bandwidth. The second system bandwidth is different than the first system bandwidth and overlaps the first system bandwidth, at least partly. Further, the first and second system bandwidths have a common frequency centre and the radio resources are useful for radio communication with mobile terminals in a cell or coverage area of the cellular network.

In this method, the network node applies a first resource block group size S1 for the first system bandwidth and applies a second resource block group size S2=N×S1 for the second system bandwidth where N is an integer. The network node further applies radio resources in the first system bandwidth according to the first resource block group size S1 and applies radio resources in the second system bandwidth according to the second resource block group size S2. The network node also signals the applied radio resources in at least one of the first and second system bandwidths to at least one mobile terminal in the cell or coverage area.

According to another aspect, a network node of a cellular network for wireless communication is configured to provide radio resources in groups of resource blocks in frequency domain in a first system bandwidth and in a second system bandwidth which is different than the first system bandwidth and overlaps the first system bandwidth. The first and second system bandwidths have a common frequency centre and the radio resources are useful for radio communication with mobile terminals in a cell or coverage area of the cellular network.

The network node comprises a logic unit and a signalling unit. The logic unit is adapted to apply a first resource block group size S1 for the first system bandwidth and to apply a second resource block group size S2=N×S1 for the second system bandwidth where N is an integer. The logic unit is also adapted to apply radio resources in the first system bandwidth according to the first resource block group size S1 and to apply radio resources in the second system bandwidth according to the second resource block group size S2. The signalling unit is adapted to signal the applied radio resources in at least one of the first and second system bandwidths to at least one mobile terminal in the cell or coverage area.

By applying a second resource block group size S2=N×S1 for the second system bandwidth where N is an integer and using a common frequency centre, the resource block group borders in the second system bandwidth will coincide with resource block borders in the first system bandwidth. It is then an advantage, e.g., that usage of a resource block group in the second system bandwidth makes N corresponding resource block groups unusable in the first system bandwidth to avoid collision, thanks to the resource block group borders coinciding across the bandwidths. Thereby, it is possible to utilize the full potential capacity without unusable parts of the available frequency spectrum.

The above method and node may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 is a communication scenario illustrating that two different bandwidth configurations are used in the same cell, according to the prior art.

FIG. 2 is a schematic diagram illustrating two bandwidth configurations with unusable resource blocks, resulting in unusable capacity.

FIG. 3 is a flow chart illustrating a procedure in a network node, according to further possible embodiments.

FIG. 4 is a schematic diagram illustrating two bandwidth configurations with resource block groups of same size, according to some possible embodiments.

FIG. 5 is a schematic diagram illustrating two bandwidth configurations with resource block groups of different sizes, according to further possible embodiments.

FIG. 6 is a block diagram illustrating a network node in more detail, according to further possible embodiments.

FIG. 7 is a schematic diagram illustrating two bandwidth configurations with resource block groups of non-aligned numberings, according to further possible embodiments.

FIG. 8 is a schematic diagram illustrating two bandwidth configurations with resource block groups of aligned numberings, according to further possible embodiments.

FIG. 9 is a schematic diagram illustrating two bandwidth configurations comprising fractional resource block groups, according to further possible embodiments.

FIG. 10 is a schematic diagram illustrating two bandwidth configurations comprising non-overlapping resource block groups of different sizes, according to further possible embodiments.

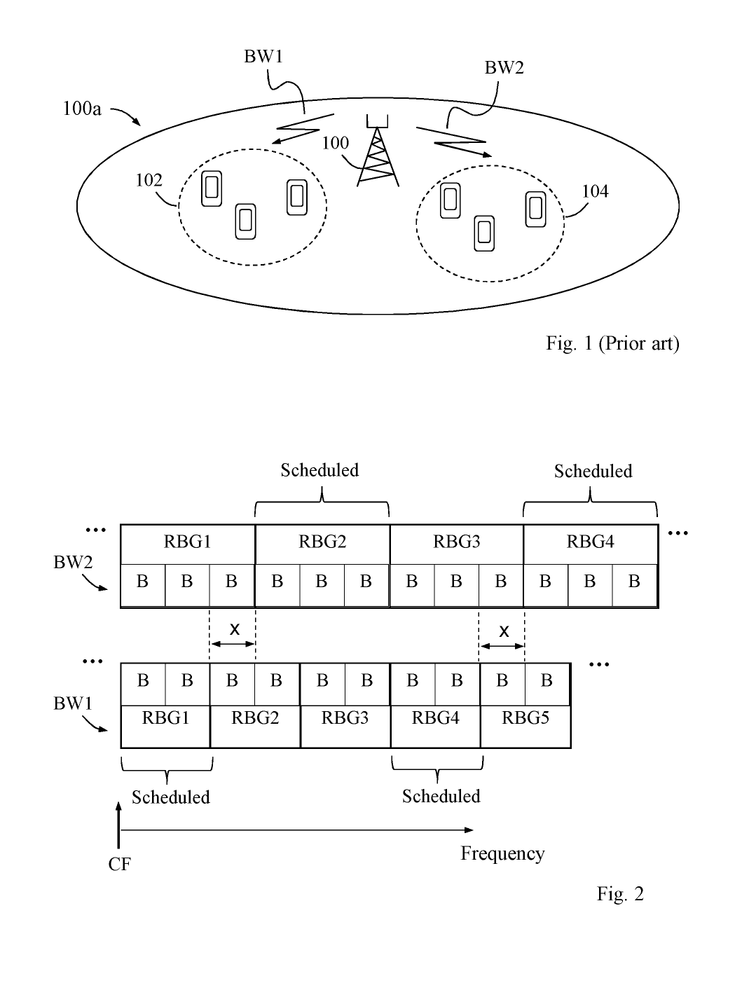

### DETAILED DESCRIPTION

In this solution it is recognized that when deploying two different configurations of system bandwidth with different numbers of resource blocks organized in resource block groups, borders of the resource block groups in one system bandwidth may not be aligned in frequency with borders of the resource block groups in the other system bandwidth. As a result, when some resource block groups in one system bandwidth are scheduled and used for radio communication with a first mobile terminal, certain resource block groups in the other system bandwidth will only partly coincide with the ones used for the first mobile terminal, due to the misalignment of group borders, and will therefore not be possible to use at the same time for another mobile terminal without collision. Some parts of the total available bandwidth may therefore become unusable and the potential capacity of the bandwidth cannot be fully utilized.

An example of how the above problem may occur in a cellular network employing two overlapping system bandwidths BW1 and BW2, is illustrated in FIG. 2 where the borders of resource block groups configured with different sizes for the two system bandwidths BW1 and BW2 are misaligned. The system bandwidths BW1 and BW2 are placed within a frequency spectrum allocated for the network such that they have a common frequency centre, e.g. in the middle of the allocated frequency spectrum, and the system bandwidths are thus overlapping one another, at least partly. The common frequency centre may be a Direct Current, DC, subcarrier which is usually applied when using multiple configurations of system bandwidth in a cellular network. In the figure, the common frequency of BW1 and BW2 centre is denoted “CF”. Each resource block group “RBG” in the first bandwidth configuration BW1 has a size of two resource blocks “B” while each resource block group RBG in the second bandwidth configuration BW2 has a size of three resource blocks B.

In this example, resource block groups RBG1 and RBG4 are currently scheduled and used in the first system bandwidth BW1 and resource block groups RBG2 and RBG4 are currently scheduled and used in the first system bandwidth BW1. RBG1 in BW1 overlaps with the first and second Bs in RBG1 of BW2 and RBG2 in BW2 overlaps with the second B in RBG2 of BW1 such that neither of RBG1 of BW2 and RBG2 of BW1 is usable for transmission. In the same manner, neither of RBG3 of BW2 and RBG5 of BW1 is usable for transmission. As a result, the parts “X” of the frequency spectrum are unusable in both system bandwidths BW1 and BW2 which means unusable capacity in the cellular network. In other words, usage of one resource block group in one bandwidth configuration, like RBG2 in BW2, may make two resource block groups unusable in the other bandwidth configuration, like RBG2 and RBG3 in BW1, due to the misalignment of resource block groups across the bandwidths and potential capacity is thereby wasted.

In this solution, the problem of unusable parts of the allocated frequency spectrum is addressed by applying radio resources in resource block groups in the two system bandwidths such that borders of overlapping resource block groups in the first and second system bandwidths are aligned in the frequency domain. As a result, usage of a resource block group in one bandwidth configuration coincides with one or more full resource block groups in the other bandwidth configuration, and not with just a part of a resource block group as in FIG. 2, thanks to the alignment of resource blocks across the bandwidths such that it is possible to utilize the full potential capacity. It is thus possible to avoid that fractions of the allocated frequency spectrum will be left that are unusable, i.e. cannot be scheduled and used for transmission due to collision across the system bandwidths, which will be described and explained in more detail below.

Although the following examples will be discussed in terms of two simultaneously used system bandwidths for simplicity, the solution is not limited to using two different system bandwidths but may be applied for any number of multiple simultaneously used system bandwidths. It is assumed that when two configurations of system bandwidth with different numbers of resource blocks are used for radio communication in a cellular network, the system bandwidths are placed within a frequency spectrum allocated for the network such that they have a common frequency centre, e.g. in the middle of the allocated frequency spectrum, and the system bandwidths are thus overlapping one another, at least partly.

The above-mentioned alignment of borders of resource block groups across two simultaneously used system bandwidths can be achieved by applying the resource block group size of one system bandwidth as being the resource block group size of the other system bandwidth multiplied by an integer which can be 1, 2, 3, and so forth, e.g. depending on the total width of the respective system bandwidths. Thus, the resource block group size of one system bandwidth will be equal to, or double, triple, etc., the resource block group size of the other system bandwidth such that the borders of the one system bandwidth will coincide in frequency with each, every second, every third, etc., border of the other system bandwidth. Thereby, no fraction(s) of the allocated frequency spectrum, such as the parts “X” in FIG. 2, will be left that cannot be scheduled and used for transmission due to collision across the system bandwidths, which will be described and explained below in terms of some illustrative examples.

The solution outlined above and in the following examples may be realized by functionality in a network node of a cellular network for wireless communication. The term “network node” is consistently used throughout this disclosure although other similar and fitting terms could be used as well. In practice, the network node described here may be implemented in a radio node, a network managing node, a radio resource managing node, a radio node controller, and so forth. A radio node may in turn be a base station, NodeB, e-NodeB, eNB, base transceiver station, relay, etc., depending on the terminology used. However, it should be noted that the network node described herein is not limited to these examples.

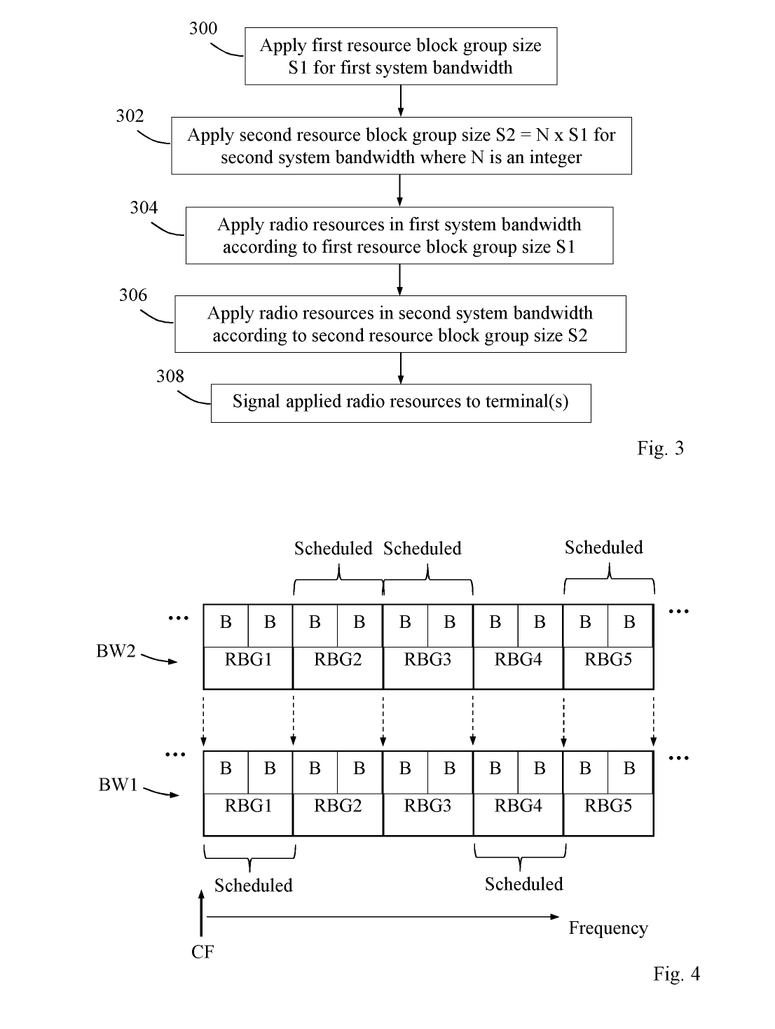

An example of how the network node may operate when employing the solution will now be described with reference to the flow chart in FIG. 3, illustrating actions performed by the network node. The network node is operable to provide radio resources in groups of resource blocks in frequency domain in a first system bandwidth and in a second system bandwidth different than the first system bandwidth and overlapping the first system bandwidth, at least partly. It is assumed that the first and second system bandwidths have a common frequency centre, the radio resources being useful for radio communication with mobile terminals present in a cell or coverage area of the cellular network.

A first action 300 illustrates that the network node applies a first resource block group size S1 for the first system bandwidth. In LTE for example, the first system bandwidth may be a predefined system bandwidth such as any of the predefined system bandwidths in the left column of Table 1 above, each being able to contain a corresponding number of resource blocks shown in the right column of Table 1. The first resource block group size S1 may in that case be determined by the sizes in Table 2 depending on the number of resource blocks contained in the first system bandwidth according to Table 1.

In an action 302, the network node further applies a second resource block group size S2=N×S1 for the second system bandwidth where N is an integer. For example, if S1 is 2, S2 can be selected to be 2, 4, 6, 8, . . . , which may depend on the total width of the second system bandwidth. In another example, if S1 is 3, S2 can be selected to be 3, 6, 9, . . . , and so forth, according to the above formula. If S2 is selected to be equal to S1, it can be easily understood that all resource block group borders can be placed in frequency so as to coincide throughout across the two system bandwidths. Before describing the remaining actions in FIG. 3, some illustrative examples of radio resource configurations are briefly outlined below.

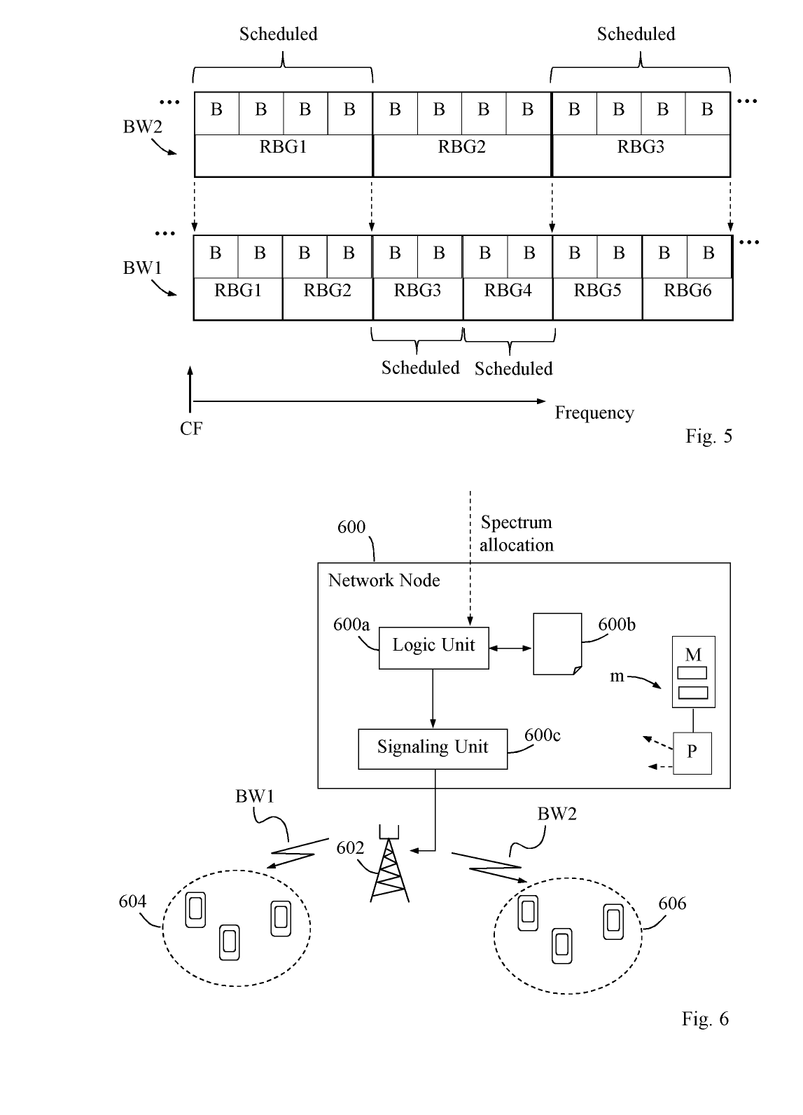

FIG. 4 and FIG. 5 illustrate two simplified examples of how the resource block group borders will coincide across the two system bandwidths BW1 and BW2 as a consequence of applying S2=N×S1. The figures only show a limited spectrum range for simplicity and the system bandwidths BW1 and BW2 may extend beyond the shown range. In the example of FIG. 4, N is 1 such that the RBG size S2 is applied as being equal to the RBG size of S1, and the resource block groups in both BW1 and BW2 contain two resource blocks B each. If the two system bandwidths BW1 and BW2 are placed symmetrically to one another in frequency, i.e. such that they have a common frequency centre CF, each RBG border of both BW1 and BW2 coincides mutually, as shown by dashed arrows. Thereby, no parts of the allocated frequency spectrum will be left that cannot be scheduled and used for transmission. In this example, RBG1 and RBG4 have been scheduled for transmission in BW1 and RBG2, RBG3 and RBG5 have been scheduled for transmission in BW2. It can be seen in the figure that no part, or resource block B, of the shown spectrum range is left unusable and the potential capacity of radio resources in the shown frequency range have been fully utilized.

In the example of FIG. 5, N is 2 such that the RBG size S2 containing four resource blocks B is applied as being twice the RBG size of S1 containing two resource blocks B. As the two system bandwidths BW1 and BW2 are symmetrically placed in frequency by having a common frequency centre CF, each RBG border of BW2 coincides with every second RBG border of BW1 as shown by dashed arrows. In this example, RBG1 and RBG3 have been scheduled for transmission in BW2, which overlap with RBGs1, 2 and RBGs 5, 6 in BW1, respectively, leaving RBG3 and RBG4 to be scheduled for transmission in BW1. It can be seen in this figure that no part, or resource block B, of the shown spectrum is left unusable and the potential capacity of radio resources have been fully utilized in this case as well.

Returning to FIG. 3, the network node applies, in a next action 304, radio resources for radio communication in the first system bandwidth according to the first resource block group size S1. The network node also applies radio resources for radio communication in the second system bandwidth according to the second resource block group size S2, in another action 306, such that borders of overlapping resource block groups in the first and second system bandwidths are aligned in the frequency domain. Since the first and second system bandwidths have a common frequency centre, e.g. the above-mentioned DC subcarrier, the resource block group borders of the overlapping resource block groups will consequently coincide in frequency across the first and second system bandwidths thanks to action 302 above. It should be noted that the second system bandwidth may be wider or narrower than the first system bandwidth and the solution allows for both cases.

In a final shown action 308, the network node signals the applied radio resources in at least one of the first and second system bandwidths to at least one mobile terminal in the cell. The applied radio resources may be signalled to multiple mobile terminals in broadcasted system information, or to an individual mobile terminal in a dedicated message. For example, the configuration of radio resources and resource block groups of the first system bandwidth may be known to the mobile terminals in beforehand, e.g. by preconfiguring or previous signalling, and it would then be sufficient to signal the configuration of radio resources and resource block groups of the second system bandwidth. Further, the signalling of the radio resources may comprise explicit signalling by signalling the resource block group sizes as such, or implicit signalling by signalling an indication or the like of the second system bandwidth such that a mobile terminal receiving the signalling is able to determine the resource block group size based on this indication.

It was mentioned above that the first system bandwidth may be a predefined system bandwidth, but the solution is not limited thereto and it is also possible that the second system bandwidth is a predefined system bandwidth such as any of the ones in Table 1. In that case, S1 may be dependent on S2 such that S1=1/N×S2, which is a consequence of the above formula S2=N×S1. S1 and S2 may thus be applied as being dependent of one another in any order. The solution thus allows for either of the first and second system bandwidths to have a size, i.e. width, and a number of contiguous resource blocks that correspond to the size and number of resource blocks of a predefined system bandwidth, e.g. one of those system bandwidths represented in the above Table 1.

The above-described actions may be performed by the network node in conjunction with further possible embodiments. In a possible embodiment, resource block groups in the first system bandwidth may be scheduled to serve a first type of mobile terminals supporting the first system bandwidth but not the second system bandwidth. Further, resource blocks in the second system bandwidth may be scheduled to serve a second type of mobile terminals supporting both the first system bandwidth and the second system bandwidth. The first type of mobile terminals may comprise legacy mobile terminals and low cost mobile terminals capable of communicating across the first system bandwidth, which may be markedly narrow, while the second type of mobile terminals may comprise more advanced mobile terminals capable of communicating across the second system bandwidth, which may be markedly wide, as well as the first system bandwidth.

In another embodiment which is possible to use in conjunction with the previous embodiment, radio resources applied in the first system bandwidth according to the first resource block group size S1 may be signalled to the first type of mobile terminals and the radio resources applied in the second system bandwidth according to the second resource block group size S2 may be signalled to the second type of mobile terminals. In a further possible embodiment, the applied radio resources may be signalled by signalling the radio resources applied in the first system bandwidth in broadcasted system information which can be read by any mobile terminals. The radio resources applied in the second system bandwidth may then be signalled in dedicated messages to the second type of mobile terminals so that the second type of mobile terminals are enabled to determine the second resource block group size S2 based on the signalled radio resources. Thereby, the needed signalling overhead can be limited so as to not occupy more bandwidth than necessary.

In another possible embodiment, the first system bandwidth may be selected from a set of predefined system bandwidths as the widest predefined system bandwidth within a frequency spectrum allocated for the cellular network, and the second resource block group size S2 may be applied based on a predefined resource block group size of the selected widest predefined system bandwidth. In the case of LTE, this may be done by selecting the first system bandwidth from Table 1 above as the widest possible system bandwidth therein that lies within the allocated frequency spectrum, and then applying the second resource block group size S2 based on the resource block group size in Table 2 that has been predefined for the number of resource blocks contained in the selected first system bandwidth. For example, S2 may be applied as being equal to the resource block group size in Table 2 for this number of resource blocks such that all resource block group borders will coincide mutually across the two system bandwidths.

A detailed but non-limiting example of how a network node of a cellular network for radio communication may be structured with some possible functional units to bring about the above-described operation of the network node, is illustrated by the block diagram in FIG. 6. In this figure, the network node 600 is configured to provide radio resources in groups of resource blocks in frequency domain in a first system bandwidth and in a second system bandwidth different than the first system bandwidth and overlapping the first system bandwidth, at least partly. It is assumed that the first and second system bandwidths have a common frequency centre and that the radio resources are useful for radio communication with mobile terminals located in a cell or coverage area of the cellular network. The network node 600 may be configured to operate according to any of the examples and embodiments described above and as follows. The network node 600 will now be described in terms of some possible examples of employing the solution.

It is further assumed that a certain frequency spectrum has been allocated to the cellular network, and information about the allocated frequency spectrum may be supplied to and used by the network node as schematically indicated by a dashed arrow. The network node 600 comprises a logic unit 600a which is adapted to apply a first resource block group size S1 for the first system bandwidth, e.g. in the manner described above for action 300. The first resource block group size S1 may in that case be selected, depending on the range of the first system bandwidth and the allocated frequency spectrum, from predefined resource block group sizes 600b valid for different total numbers of resource blocks within a system bandwidth, e.g. according to Table 2. The logic unit 600a is further adapted to apply a second resource block group size S2=N×S1 for the second system bandwidth where N is an integer, e.g. in the manner described above for action 302.

The logic unit 600a is also adapted to apply radio resources in the first system bandwidth according to the first resource block group size S1, and to apply radio resources in the second system bandwidth according to the second resource block group size S2 such that borders of overlapping resource block groups in the first and second system bandwidths are aligned in the frequency domain, e.g. in the manner described above for actions 304 and 306, respectively.

The network node 600 also comprises a signalling unit 600c which is adapted to signal the applied radio resources in at least one of the first and second system bandwidths to the mobile terminals in the cell, e.g. in the manner described above for action 308. The above network node 600 and its functional units may be configured or adapted to operate according to various optional embodiments. In a possible embodiment, the network node 600 is adapted to schedule resource block groups in the first system bandwidth to serve a first type of mobile terminals 604 supporting the first system bandwidth but not the second system bandwidth, and to schedule resource blocks in the second system bandwidth to serve a second type of mobile terminals 606 supporting the first system bandwidth and the second system bandwidth.

In another possible embodiment, the signalling unit 600c may be adapted to signal radio resources applied in the first system bandwidth according to the first resource block group size S1 to the first type of mobile terminals, and to signal the radio resources applied in the second system bandwidth according to the second resource block group size S2 to the second type of mobile terminals. The signalling unit 600c may also be adapted to signal the applied radio resources by signalling the radio resources applied in the first system bandwidth in broadcasted system information and signalling the radio resources applied in the second system bandwidth in dedicated messages to the second type of mobile terminals so that the second type of mobile terminals are enabled to determine the second resource block group size S2 based on the signalled radio resources.

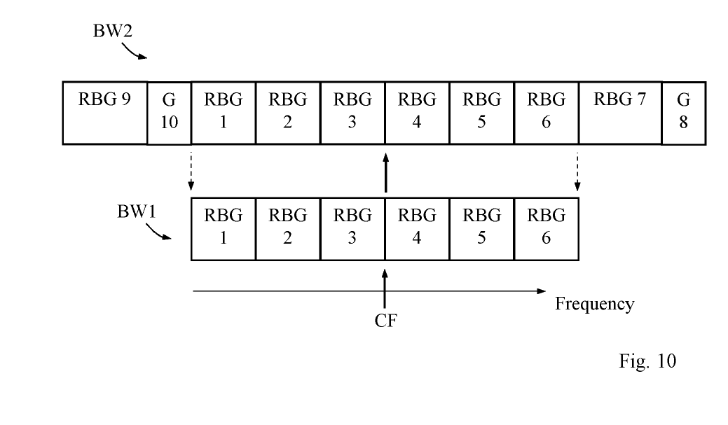

In another possible embodiment, in a case where the second system bandwidth is wider than the first system bandwidth, the logic unit 600a may be adapted to apply at least a third resource block group size S3, being different than the second resource block group size S2, for resource block groups in the second system bandwidth not overlapping with the first system bandwidth, which is exemplified in FIG. 10. Further, a numbering of resource block groups in the second system bandwidth may be aligned with a numbering of resource block groups in an overlapped part of the first system bandwidth, which is exemplified in FIGS. 8 and 10.

In another possible embodiment, the logic unit 600a may be adapted to select the first system bandwidth from a set of predefined system bandwidths as the widest predefined system bandwidth within a frequency spectrum allocated for the cellular network, and to apply the second resource block group size S2 based on a predefined resource block group size of the selected widest predefined system bandwidth.

It should be noted that FIG. 6 illustrates some possible functional units in the network node 600 and the skilled person is able to implement these functional units in practice using suitable software and hardware. Thus, the solution is generally not limited to the shown structures of the network node 600, and the functional units 600a and c may be configured to operate according to any of the features described in this disclosure, where appropriate.

The functional units 600a and c described above may be implemented in the network node 600 by means of program modules of a respective computer program comprising code means which, when run by a processor “P” causes the network node 600 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the network node 600 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the network node 600.

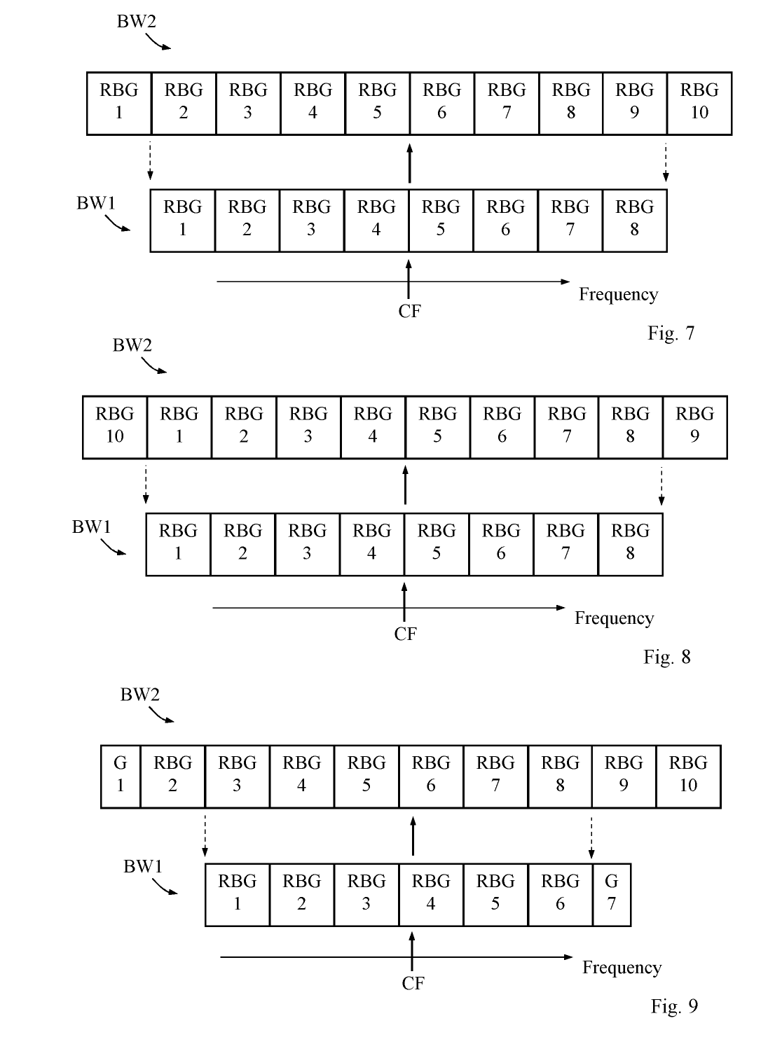

Some examples of how resource block groups RBGs may be configured and numbered in two simultaneously employed system bandwidths BW1 and BW2 where their resource block group borders are aligned by implementing the solution described above, will now be described with reference to FIGS. 7-10. In FIG. 7, all RBGs in both BW1 and BW2 have the same size, i.e. equal number of resource blocks in each RBG such that the first resource block group size S1 is equal to the second resource block group size S2. BW1 and BW2 are both centered around a common frequency centre CF and BW1 contains 8 RBGs while BW2 is wider and contains 10 RBGs. In this example, a “linear” numbering scheme is applied for the RBGs in both BW1 and BW2 such that BW1 and BW2 start with RBG1 and end with RBG8 in BW1 and with RBG10 in BW2. Thereby, RBG1 in BW1 coincide with RBG2 in BW2, RBG2 in BW1 coincide with RBG3 in BW2, RBG3 in BW1 coincide with RBG4 in BW2, and so forth. Since BW2 is wider than BW1, The first and last RBGs of BW2 are placed in frequency on either side of the BW1 range, namely RBG1 of BW2 is below BW1 and RBG10 of BW2 is above BW1.

In FIG. 8, all RBGs in both BW1 and BW2 have again the same size such that the first resource block group size S1 is equal to the second resource block group size S2, and BW1 and BW2 are both centered around a common frequency centre CF. As in the example of FIG. 7, BW1 contains 8 RBGs while BW2 is wider and contains 10 RBGs. In this example, a numbering scheme is applied for the RBGs in BW1 and BW2 such that RBGs in BW1 and BW2 coinciding in frequency are numbered equally by starting the numbering of RBGs in BW1 and BW2 at the same frequency where the narrower range of BW1 starts. Thereby, RBG1 in BW1 coincide with RBG1 in BW2, RBG2 in BW1 coincide with RBG2 in BW2, RBG3 in BW1 coincide with RBG3 in BW2, and so forth. An advantage that may be achieved by such a numbering scheme is that the same RBG in both BW1 and BW2 can be addressed jointly by the same RBG number for both BW1 and BW2 in a broadcast message or the like in the cell, which may save signalling overhead. In addition, the two RBGs of BW2 placed on either side of the range of BW1, are numbered such that the numbering continues from RBG8 with RBG9 above BW1 and the numbering then continues with RBG10 below BW1, in a “wrap-around” fashion. Thereby, the numbering of resource block groups in the second system bandwidth BW2 is aligned with the numbering of resource block groups in an overlapped part of the first system bandwidth BW1.

FIG. 9 illustrates another example of RBG configuration where BW1 and BW2 are both centered around a common frequency centre CF and BW1 contains only 7 RBGs while BW1 is wider and contains 10 RBGs. In this example, the RBGs in both BW1 and BW2 have the same size, i.e. equal number of resource blocks in each RBG, along a part of the frequency range where BW1 and BW2 overlap one another, namely RBG1-RBG6 in BW1 and RBG3-RBG8 in BW2, respectively. In other words, the first resource block group size S1 is equal to the second resource block group size S2 within this overlapping part. A linear numbering scheme is applied for the RBGs in both BW1 and BW2 by starting with RBG1 and ending with RBG7 in BW1 and with RBG10 in BW2. In this example, the last RBG “G7” of BW1 and the first RBG “G1” of BW2 are smaller, e.g. due to limitations in the allocated frequency range, and thus contain less resource blocks than the other RBGs. It is also possible to employ a wrap-around numbering scheme for BW2 in this case as well, not shown, by letting the RBG numbering in BW2 coincide in frequency from RBG1 to RBG 6 in BW1 and then continue the numbering with RBG 7, 8 above the range of BW1 and then RBG 9, 10 below the range of BW1, like the manner shown in the example of FIG. 8.

FIG. 10 illustrates yet another example of RBG configuration where BW1 and BW2 are likewise both centered around a common frequency centre CF and BW1 contains 6 RBGs while BW1 is wider and contains 10 RBGs. In this example, the RBGs in both BW1 and BW2 have the same size, i.e. equal number of resource blocks in each RBG, and are also uniformly numbered along a part of the frequency range where BW1 and BW2 overlap one another, namely RBG1-RBG6 in both BW1 and BW2, thus creating aligned resource block group borders. Again, the first resource block group size S1 is equal to the second resource block group size S2 within this overlapping part. In this example, the RBGs of BW2 lying outside the range of BW1, namely RBGs 7-10, are of different sizes than RBG1-RBG6 as shown in this figure, which is possible without creating unusable resource blocks since they do not coincide with any RBGs in BW1. In other words, the second system bandwidth BW2 is wider than the first system bandwidth BW1 and at least a third resource block group size S3, being different than the second resource block group size S2, is applied for resource block groups in the second system bandwidth BW2 not overlapping with the first system bandwidth BW1.

While the solution has been described with reference to specific exemplary embodiments, the description is generally only intended to illustrate the inventive concept and should not be taken as limiting the scope of the solution. For example, the terms “radio node”, “network node”, “mobile terminal” “resource blocks” and “resource block groups” have been used throughout this description, although any other corresponding entities, functions, and/or parameters could also be used having the features and characteristics described here. The solution is defined by the appended claims.

1-14. (canceled)

15. A method performed by a network node of a cellular network for wireless communication, for providing radio resources in groups of resource blocks in frequency domain in a first system bandwidth and in a second system bandwidth different than the first system bandwidth and overlapping the first system bandwidth, wherein the first and second system bandwidths have a common center frequency, the radio resources being useful for radio communication with mobile terminals in a cell or coverage area of the cellular network, the method comprising:
applying a first resource block group size S1 for the first system bandwidth;
applying a second resource block group size S2=N×S1 for the second system bandwidth, where N is an integer;
applying radio resources in the first system bandwidth according to the first resource block group size S1;
applying radio resources in the second system bandwidth according to the second resource block group size S2; and
signaling the applied radio resources in at least one of the first and second system bandwidths to at least one mobile terminal in the cell or coverage area.

16. The method of claim 15, wherein resource block groups in the first system bandwidth are scheduled to serve a first type of mobile terminals supporting the first system bandwidth but not the second system bandwidth, and resource blocks in the second system bandwidth are scheduled to serve a second type of mobile terminals supporting the first system bandwidth and the second system bandwidth.

17. The method of claim 16, wherein radio resources applied in the first system bandwidth according to the first resource block group size S1 are signaled to the first type of mobile terminals and the radio resources applied in the second system bandwidth according to the second resource block group size S2 are signaled to the second type of mobile terminals.

18. The method of claim 16, wherein the applied radio resources are signaled by signaling the radio resources applied in the first system bandwidth in broadcasted system information and signaling the radio resources applied in the second system bandwidth in dedicated messages to the second type of mobile terminals, so that the second type of mobile terminals are enabled to determine the second resource block group size S2 based on the signaled radio resources.

19. The method of claim 15, wherein the second system bandwidth is wider than the first system bandwidth, and wherein at least a third resource block group size S3, being different than the second resource block group size S2, is applied for resource block groups in the second system bandwidth not overlapping with the first system bandwidth.

20. The method of claim 15, wherein a numbering of resource block groups in the second system bandwidth is aligned with a numbering of resource block groups in an overlapped part of the first system bandwidth.

21. The method of claim 15, wherein the first system bandwidth is selected from a set of predefined system bandwidths as the widest predefined system bandwidth within a frequency spectrum allocated for the cellular network, and wherein the second resource block group size S2 is applied based on a predefined resource block group size of the selected widest predefined system bandwidth.

22. A network node of a cellular network for wireless communication, the network node being configured to provide radio resources in groups of resource blocks in frequency domain in a first system bandwidth and in a second system bandwidth different than the first system bandwidth and overlapping the first system bandwidth, wherein the first and second system bandwidths have a common center frequency, the radio resources being useful for radio communication with mobile terminals in a cell or coverage area of the cellular network, the network node comprising a processing circuit configured to:
apply a first resource block group size S1 for the first system bandwidth;
apply a second resource block group size S2=N×S1 for the second system bandwidth, where N is an integer;
apply radio resources in the first system bandwidth according to the first resource block group size S1;
apply radio resources in the second system bandwidth according to the second resource block group size S2; and
signal the applied radio resources in at least one of the first and second system bandwidths to at least one mobile terminal in the cell or coverage area.

23. The network node of claim 22, wherein the processing circuit is configured to schedule resource block groups in the first system bandwidth to serve a first type of mobile terminals supporting the first system bandwidth but not the second system bandwidth, and to schedule resource blocks in the second system bandwidth to serve a second type of mobile terminals supporting the first system bandwidth and the second system bandwidth.

24. The network node of claim 23, wherein the processing circuit is configured to signal radio resources applied in the first system bandwidth according to the first resource block group size S1 to the first type of mobile terminals, and to signal the radio resources applied in the second system bandwidth according to the second resource block group size S2 to the second type of mobile terminals.

25. The network node of claim 23, wherein the processing circuit is configured to signal the applied radio resources by signaling the radio resources applied in the first system bandwidth in broadcasted system information and signaling the radio resources applied in the second system bandwidth in dedicated messages to the second type of mobile terminals so that the second type of mobile terminals are enabled to determine the second resource block group size S2 based on the signaled radio resources.

26. The network node of claim 22, wherein the second system bandwidth is wider than the first system bandwidth, and wherein the processing circuit is configured to apply at least a third resource block group size S3, being different than the second resource block group size S2, for resource block groups in the second system bandwidth not overlapping with the first system bandwidth.

27. The network node of claim 22 wherein a numbering of resource block groups in the second system bandwidth is aligned with a numbering of resource block groups in an overlapped part of the first system bandwidth.

28. The network node of claim 22, wherein the processing circuit is configured to select the first system bandwidth from a set of predefined system bandwidths as the widest predefined system bandwidth within a frequency spectrum allocated for the cellular network, and to apply the second resource block group size S2 based on a predefined resource block group size of the selected widest predefined system bandwidth.
